(19) United States
(12) Patent Application Publication
(10) Pub. No.: US 2026/0171548 A1
(43) Pub. Date: Jun. 18, 2026

(54) ENERGY STORAGE DEVICE

(71) Applicant: TOYOTA JIDOSHA KABUSHIKI KAISHA, Toyota-shi (JP)

(72) Inventor: Yoshikazu NAKAMURA, Toyota-shi (JP)

(73) Assignee: TOYOTA JIDOSHA KABUSHIKI KAISHA, Toyota-shi (JP)

(21) Appl. No.: 19/386,260

(22) Filed: Nov. 12, 2025

(30) Foreign Application Priority Data
Dec. 12, 2024 (JP) 2024-217506

(51) Int. Cl. H01M 10/6568; H01M 10/613; H01M 50/342

(52) U.S. Cl. CPC H01M 10/6568; H01M 10/613; H01M 50/3425

(57) ABSTRACT

An energy storage device includes: a plurality of bipolar batteries arranged in an arrangement direction; a housing case that houses the bipolar batteries; and a cooler disposed between adjacent ones of the bipolar batteries in the arrangement direction and including a flow path provided therein. When viewed in the arrangement direction, the cooler includes a first protruding portion that protrudes into the housing case from between the bipolar batteries, and a second protruding portion that protrudes out of the housing case. A weak portion configured to rupture at a pressure lower than a pressure resistance limit of the housing case is provided on each of the first protruding portion and the second protruding portion.

### CROSS-REFERENCE TO RELATED APPLICATION

This application claims priority to Japanese Patent Application No. 2024-217506 filed on December 12, 2024. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

Japanese Unexamined Patent Application Publication No. 2023-177537 (JP 2023-177537 A) discloses an energy storage device in which a plurality of bipolar batteries and a plurality of coolers are alternately stacked and housed within a housing case, and a cooling medium flows through the interior of each cooler.

### SUMMARY

When a bipolar battery generates heat, gas may be produced and released into the interior of the housing case. As a result, the internal pressure of the housing case increases, and if no countermeasures are taken, the increase in pressure may cause damage to the housing case or to components housed within the housing case.

The present disclosure has been made in view of the above issue, and an object thereof is to provide an energy storage device capable of discharging gas to the outside of a housing case using a cooler.

An energy storage device according to the present disclosure includes: a plurality of bipolar batteries arranged in an arrangement direction; a housing case that houses the bipolar batteries; and a cooler disposed between adjacent ones of the bipolar batteries in the arrangement direction and including a flow path provided therein. When viewed in the arrangement direction, the cooler includes a first protruding portion that protrudes into the housing case from between the bipolar batteries, and a second protruding portion that protrudes out of the housing case. A weak portion configured to rupture at a pressure lower than a pressure resistance limit of the housing case is provided on each of the first protruding portion and the second protruding portion.

In the energy storage device according to the present disclosure, the arrangement direction may be parallel to a vertical direction. The cooler may include an upper surface and a lower surface that are aligned in the arrangement direction. The weak portion provided on the first protruding portion may be provided on the upper surface, and the weak portion provided on the second protruding portion may be provided on the lower surface.

In the energy storage device according to the present disclosure, the flow path may be configured to allow a flammable cooling oil to flow therethrough.

According to the present disclosure, it is possible to provide an energy storage device capable of discharging gas to the outside of a housing case using a cooler.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an energy storage device according to an embodiment;

FIG. 2 is a cross-sectional view of a bipolar battery according to the embodiment; and

FIG. 3 is a diagram illustrating how gas is discharged from a cooler in the energy storage device according to the embodiment.

### DETAILED DESCRIPTION OF EMBODIMENTS

Hereinafter, an embodiment of the present disclosure will be described in detail with reference to the drawings. In the following embodiment, the same or common portions are denoted by the same signs throughout the drawings, and description thereof will not be repeated.

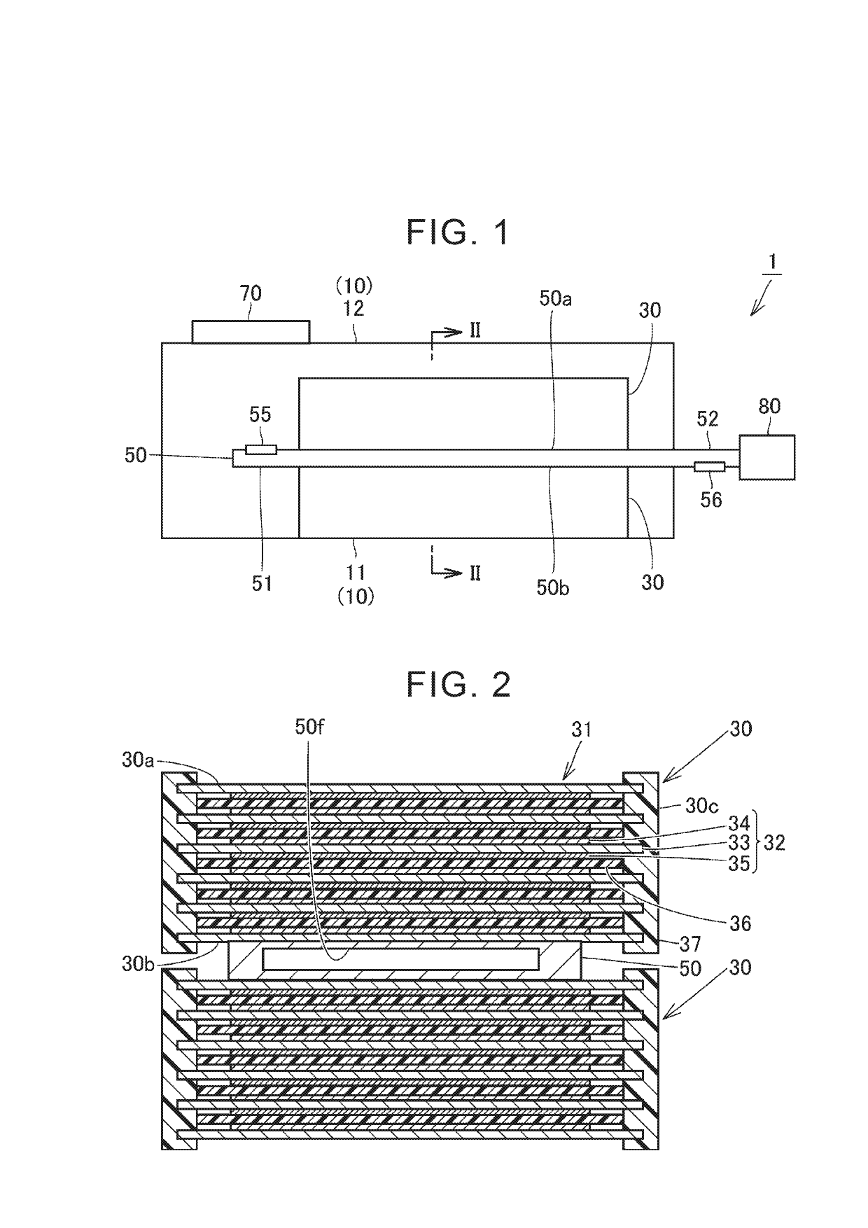

FIG. 1 is a schematic diagram of an energy storage device according to an embodiment. An energy storage device 1 according to the embodiment will be described with reference to FIG. 1.

The energy storage device 1 is mounted on, for example, a vehicle such as a hybrid electric vehicle (HEV), a plug-in hybrid electric vehicle (PHEV), or a battery electric vehicle (BEV). For example, the energy storage device 1 may be mounted below a floor panel of the vehicle or below a seat inside the vehicle cabin.

As shown in FIG. 1, the energy storage device 1 includes a plurality of bipolar batteries 30, a cooler 50, and a housing case 10. The bipolar batteries 30 are arranged in an arrangement direction. The arrangement direction is, for example, a direction parallel to the vertical direction.

The housing case 10 houses the bipolar batteries 30. The housing case 10 includes a lower case 11 and an upper case 12. The lower case 11 has a generally box-shaped configuration that is open at the top. The upper case 12 closes the opening of the lower case 11. The lower case 11 and the upper case 12 may be made of a metal such as stainless steel (SUS). A pressure relief valve 70 may be provided on the upper case 12.

The pressure relief valve 70 is configured to open when the pressure inside the housing case 10 becomes greater than or equal to a predetermined pressure. When the pressure relief valve 70 is provided, the predetermined pressure at which the pressure relief valve 70 opens serves as the pressure resistance limit of the housing case 10.

However, as will be described later, in a case where gas is discharged from a bipolar battery 30 and the gas can be sufficiently discharged using the cooler 50, the pressure relief valve 70 may be omitted. In that case, the pressure at which the housing case 10 is damaged or deformed due to an internal pressure increase serves as the pressure resistance limit of the housing case 10.

The cooler 50 is disposed between adjacent bipolar batteries 30 in the arrangement direction. The cooler 50 is made of an electrically conductive metal, and electrically connects the adjacent bipolar batteries 30.

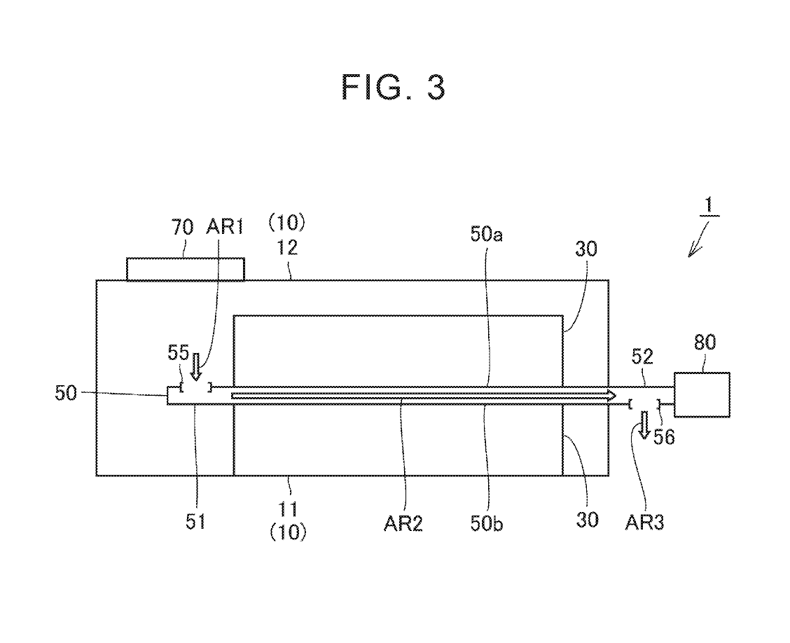

The cooler 50 includes a flow path 50f provided therein (see FIG. 2). A cooling medium flows through the flow path 50f. The cooling medium may be either a liquid or a gas. A known cooling oil may be used as the liquid cooling medium. The cooling oil may be flammable or nonflammable.

The cooler 50 has an upper surface 50a and a lower surface 50b that are aligned in the arrangement direction. When viewed in the arrangement direction, the cooler 50 includes a first protruding portion 51 that protrudes into the housing case 10 from between the bipolar batteries 30, and a second protruding portion 52 that protrudes out of the housing case 10.

For example, the first protruding portion 51 protrudes in a direction perpendicular to the arrangement direction. A weak portion 55 is provided on the first protruding portion 51. The weak portion 55 is provided on the upper surface 50a. The weak portion 55 is configured to rupture at a pressure lower than the pressure resistance limit of the housing case 10.

The second protruding portion 52 protrudes in the opposite direction to the direction in which the first protruding portion 51 protrudes. A weak portion 56 is provided on the second protruding portion 52. The weak portion 56 is provided on the lower surface 50b. The weak portion 56 is configured to rupture at a pressure lower than the pressure resistance limit of the housing case 10.

The second protruding portion 52 is connected to a heat exchanger 80, and the cooling medium flowing inside the cooler 50 is cooled by the heat exchanger 80.

FIG. 2 is a cross-sectional view of a bipolar battery according to the embodiment. FIG. 2 shows a cross-sectional view of a bipolar battery 30 taken along line II–II in FIG. 1. The bipolar battery 30 according to the present embodiment will be described in detail with reference to FIG. 2.

As shown in FIG. 2, the bipolar battery 30 has a generally rectangular parallelepiped shape. The bipolar battery 30 includes an upper surface portion 30a, a lower surface portion 30b, and a peripheral surface portion 30c. The bipolar battery 30 includes a plurality of bipolar electrodes 32, a plurality of separators 36, and a sealing portion 37.

The bipolar electrode 32 includes an electrode plate 33 and electrode layers 34, 35. The electrode plate 33 is formed in a plate shape, and has a first main surface and a second main surface that are aligned in the up-down direction.

The electrode layers 34, 35 are formed inside the periphery of the electrode plate 33. The electrode layer 34 is provided on the first main surface of the electrode plate 33 located on one side in the up-down direction. The electrode layer 35 is provided on the second main surface of the electrode plate 33 located on the other side in the up-down direction.

The electrode layer 34 serves as a cathode and includes a cathode active material layer. Any known material may be used as the cathode active material. In addition to the cathode active material, the electrode layer 34 may contain an electrically conductive material and a binder. The electrode layer 35 serves as an anode and includes an anode active material. Any known material may be used as the cathode active material.

The separator 36 is disposed between the electrode layers 34, 35 formed on adjacent bipolar electrodes 32 as described above. Specifically, the separator 36 is disposed between the electrode layer 35 of the bipolar electrode 32 located on one side in the up-down direction and the electrode layer 34 of the bipolar electrode 32 located on the other side in the up-down direction.

The separator 36 is formed, for example, in a sheet shape. Examples of the separator 36 include porous films made of polyolefin-based resins such as polyethylene (PE) and polypropylene (PP), and woven or nonwoven fabrics made of materials such as polypropylene, polyethylene terephthalate (PET), or methyl cellulose. The separator 36 may be one reinforced with a vinylidene fluoride resin compound.

The sealing portion 37 seals the peripheral edges of the bipolar electrodes 32 so as to form a space between adjacent bipolar electrodes 32 in the up-down direction. The sealing portion 37 seals the space. The peripheral surface portion 30c of the bipolar battery 30 is defined by the outer peripheral surface of the sealing portion 37.

The peripheral edges of the bipolar electrodes 32 are embedded in the sealing portion 37. The sealing portion 37 thus holds the bipolar electrodes 32.

The sealing portion 37 is made of, for example, an insulating resin. The sealing portion 37 may be made of, for example, polypropylene (PP), polyphenylene sulfide (PPS), or modified polyphenylene ether (modified PPE).

An electrolyte solution is contained in the space formed between the bipolar electrodes 32. The electrode layers 34, 35 and the separator 36 are impregnated with the electrolyte solution.

FIG. 3 is a diagram illustrating how gas is discharged from the cooler in the energy storage device according to the present embodiment.

As shown in FIG. 3, when any of the bipolar batteries 30 generates heat and gas is released from the bipolar battery 30 into the housing case 10, the pressure inside the housing case 10 increases, causing the weak portion 55 having a lower pressure resistance than the housing case 10 to rupture. As a result, the flow path 50f inside the cooler 50 communicates with the internal space of the housing case 10 through the ruptured portion. At this time, the gas inside the housing case 10 presses against the flow path 50f, increasing the internal pressure of the flow path 50f and causing the weak portion 56 provided on the second protruding portion 52 to rupture. The inside and outside of the housing case 10 thus become connected via the ruptured weak portions 55, 56 and the flow path 50f.

As a result, as indicated by arrows AR1, AR2, AR3, the gas released into the housing case 10 is discharged to the outside of the housing case 10 through the ruptured weak portion 55, the flow path 50f, and the ruptured weak portion 56. In this way, in the energy storage device 1 according to the present embodiment, the gas released from the bipolar battery 30 into the housing case 10 can be discharged to the outside of the housing case 10 by using the cooler 50.

Similarly, the cooling medium flowing through the flow path 50f is also discharged to the outside of the housing case 10 through the weak portion 56. Since the pressure inside the housing case 10 is high at the side of the ruptured weak portion 55, leakage of the cooling medium from the ruptured weak portion 55 into the housing case 10 can be suppressed. In particular, when a flammable cooling oil is used as the cooling medium, leakage of the cooling oil into the housing case 10 can be suppressed, thereby improving the safety of the energy storage device 1.

Furthermore, since the weak portion 55 disposed inside the housing case 10 is provided on the upper surface 50a, leakage of the liquid cooling medium into the housing case 10 from the ruptured weak portion 55 can be effectively suppressed, compared to a case where the weak portion 55 is provided on the lower surface 50b. Since the weak portion 56 disposed outside the housing case 10 is provided on the lower surface 50b, the liquid cooling medium can be more effectively discharged to the outside of the housing case 10.

The above embodiment illustrates a case where two bipolar batteries 30 are arranged and a single cooler 50 is disposed therebetween. However, the present disclosure is not limited to this. The number of bipolar batteries 30 may be three or more, as long as a cooler 50 is disposed between each pair of adjacent bipolar batteries 30. In this case, at least one of the coolers 50 may be provided with the first protruding portion 51, the second protruding portion 52, and the weak portions 55, 56. Alternatively, each of the coolers 50 may be provided with the first protruding portion 51, the second protruding portion 52, and the weak portions 55, 56.

The bipolar battery 30 may be of a pouch type or a laminate type.

The embodiment disclosed herein should be considered to be illustrative in all respects and not restrictive. The scope of the present disclosure is defined by the claims, and includes all modifications within the meaning and scope equivalent to the claims.

What is claimed is:

1. An energy storage device comprising:
a plurality of bipolar batteries arranged in an arrangement direction;
a housing case that houses the bipolar batteries; and
a cooler disposed between adjacent ones of the bipolar batteries in the arrangement direction, the cooler including a flow path provided inside the cooler, wherein:
when viewed in the arrangement direction, the cooler includes a first protruding portion that protrudes into the housing case from between the bipolar batteries, and a second protruding portion that protrudes out of the housing case; and
a weak portion configured to rupture at a pressure lower than a pressure resistance limit of the housing case is provided on each of the first protruding portion and the second protruding portion.

2. The energy storage device according to claim 1, wherein:
the arrangement direction is parallel to a vertical direction;
the cooler includes an upper surface and a lower surface that are aligned in the arrangement direction;
the weak portion provided on the first protruding portion is provided on the upper surface; and
the weak portion provided on the second protruding portion is provided on the lower surface.

3. The energy storage device according to claim 1, wherein the flow path is configured to allow a flammable cooling oil to flow through the flow path.
